(19) United States
(12) Patent Application Publication
(10) Pub. No.: US 2018/0257247 A1
(43) Pub. Date: Sep. 13, 2018

(54) SWITCH STRUCTURE FOR PLIERS

(71) Applicant: CHING-CHEN YANG, Taichung City (TW)

(72) Inventor: CHING-CHEN YANG, Taichung City (TW)

(21) Appl. No.: 15/453,831

(22) Filed: Mar. 8, 2017

(51) Int. Cl. B26B 13/16; B26B 13/28

(52) U.S. Cl. CPC B26B 13/16; B26B 13/28

(57) ABSTRACT

A switch structure for pliers contains: a first operation part, a second operation part, a first spring, a fastener, and a limitation member. The first operation part is rotatably connected with the second operation part so as to form a first grip, a second grip, a first cutting plier, and a second cutting plier. The first spring is defined between the first grip and the second grip, and the first grip has a notch. The fastener is rotatably connected with the first grip and includes a hook and a coupling extension. The limitation member partially extends out of the notch and movably fits on the coupling segment, and the limitation member includes a wide-diameter section for retaining with the notch and includes a narrow-diameter section for removing the limitation member from the fastener, wherein the second grip has a fixing post configured to retain with the hook.

### FIELD OF THE INVENTION

The present invention relates to a switch structure which locks the pliers securely and safely.

### BACKGROUND OF THE INVENTION

Conventional pliers contain two operation parts which are rotatably connected together, wherein each operation part has a cutting plier so as to clamp and unclamp an object by operation the two operation parts.

Another conventional pliers are disclosed in TW Patent No. 097104419 and contains a body which has a first operation part and a second operation part, wherein the first operation part has a first grip and a first cutting plier, and the second operation part has a second grip and a second cutting plier. The first grip has a hooking portion correspond to the second grip, and the second grip has a locking trench corresponding to the hooking portion of the first grip, hence the hooking portion locks with the locking trench so as to fix the first grip and the second grip.

However, when the conventional pliers drop on the floor, the hooking portion removes from the locking trench easily, and the first grip and the second grip cannot be fixed securely.

The present invention has arisen to mitigate and/or obviate the afore-described disadvantages.

### SUMMARY OF THE INVENTION

The primary objective of the present invention is to provide a switch structure which locks the pliers securely and safely.

To obtain the above objective, a switch structure contains: a first cutting member, a second cutting member, and a connection post.

The first operation part is rotatably connected with the second operation part so as to form a first grip, a second grip, a first cutting plier, and a second cutting plier, wherein the first spring is defined between the first grip and the second grip and pushes the first grip, the second first, the first cutting plier, and the second cutting plier, wherein the first grip has a notch formed on a peripheral side thereof.

The fastener is rotatably connected with the first grip, and the fastener includes a hook arranged on a first end thereof and corresponding to the second grip, the fastener also includes a coupling extension formed on a second end thereof and corresponding to the notch.

The limitation member partially extends out of the notch and movably fits on the coupling segment of the fastener, and the limitation member includes a wide-diameter section configured to retain with the notch so as to limit the fastener, and the limitation member also includes a narrow-diameter section configured to remove the limitation member from the fastener, wherein the second grip has a fixing post configured to retain with the hook.

Preferably, the fastener further includes a first retraction section and a second retraction section which are formed respectively on two sides of the coupling segment of the fastener, and the limitation member further includes a locking protrusion formed on an inner side thereof opposite to the narrow-diameter section and alternatively locking with the first retraction section or the second retraction section; wherein when the locking protrusion locks with the first retraction section, the wide-diameter section corresponds to the notch; wherein when the locking protrusion locks with the second retraction section, the narrow-diameter section corresponds to the notch.

Preferably, the fastener further includes a defining column arranged on the coupling segment, and the limitation member further includes two accommodation grooves respectively defined on two sides thereof so as to accommodate the defining column.

Preferably, the limitation member further includes an operation tab extending out of the notch.

Preferably, the switch structure further contains a second spring rotatably fitted on the fastener, wherein a first end of the second spring abuts against the first grip, and a second end of the second spring is biased against the fastener so that one end of the hook of the fastener removes from the fixing post.

### BRIEF DESCRIPTION OF THE DRAWINGS

FIG. 1 is a perspective view showing the exploded components of a switch structure for pliers according to a preferred embodiment of the present invention.

FIG. 2 is a perspective view showing the assembly of the switch structure for the pliers according to the preferred embodiment of the present invention.

FIG. 3 is a cross sectional view showing the operation of a part of the pliers according to the preferred embodiment of the present invention.

FIG. 4 is a cross sectional view showing the operation of a part of the switch structure for the pliers according to the preferred embodiment of the present invention.

FIG. 5 is another cross sectional view showing the operation of a part of the switch structure for the pliers according to the preferred embodiment of the present invention.

FIG. 6 is also another cross sectional view showing the operation of a part of the switch structure for the pliers according to the preferred embodiment of the present invention.

### DETAILED DESCRIPTION OF THE PREFERRED EMBODIMENTS

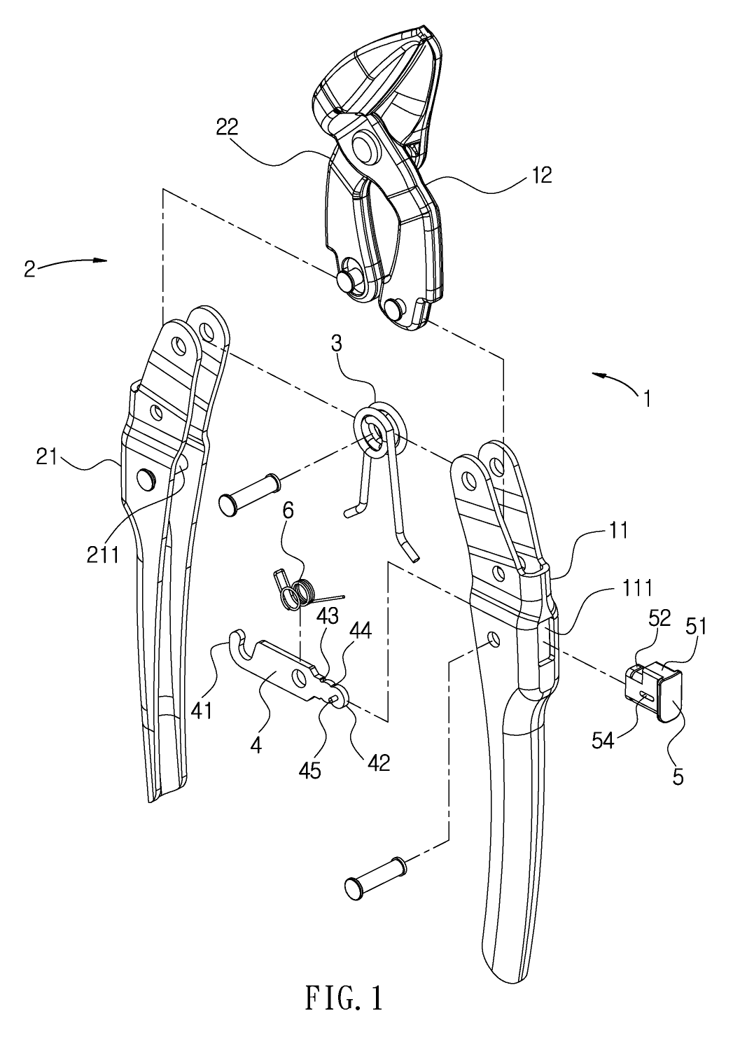

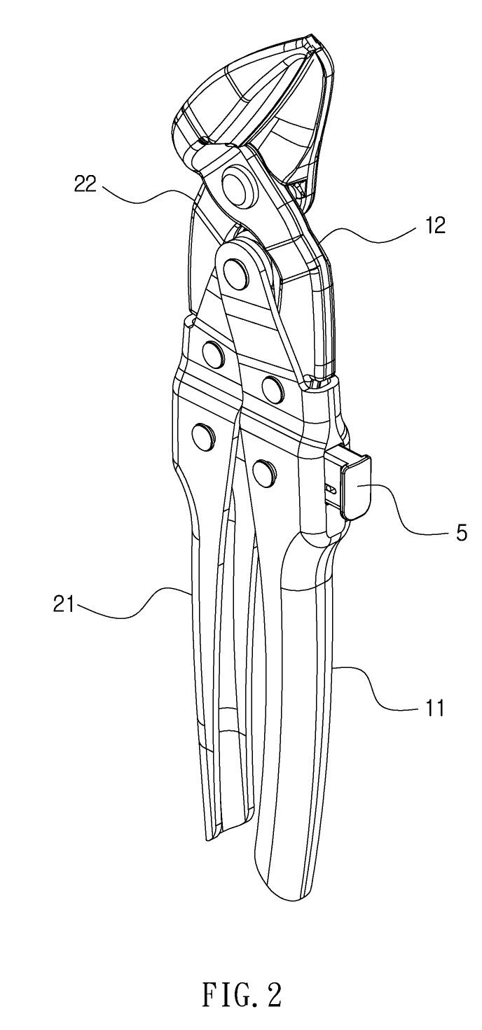

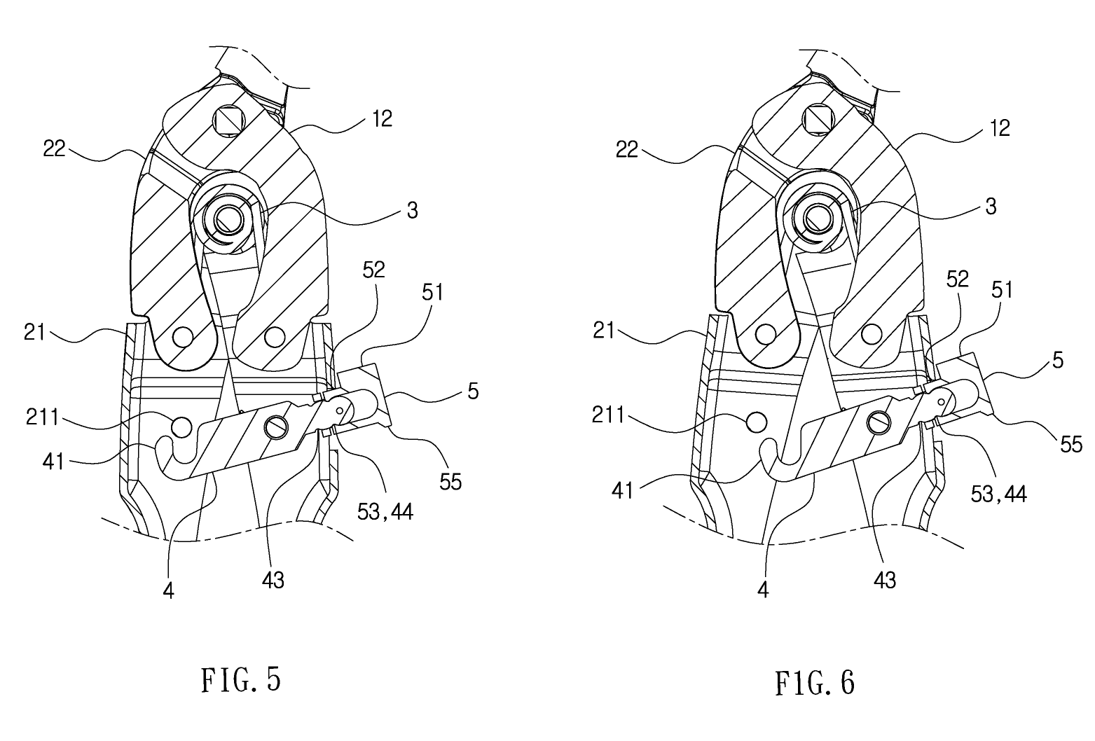

With reference to FIGS. 1 to 6, a switch structure for pliers according to a preferred embodiment of the present invention comprises: a first operation part 1, a second operation part 2, a first spring 3, a fastener 4, and a limitation member 5.

The first operation part 1 is rotatably connected with the second operation part 2 so as to form a first grip 11, a second grip 21, a first cutting plier 12, and a second cutting plier 22. The first spring 3 is defined between the first grip 11 and the second grip 21 and pushes the first grip 11, the second first 21, the first cutting plier 12, and the second cutting plier 22, wherein the first grip 11 has a notch 111 formed on a peripheral side thereof.

The fastener 4 is rotatably connected with the first grip 11, and the fastener 4 includes a hook 41 arranged on a first end thereof and corresponding to the second grip 21, the fastener 4 also includes a coupling extension 42 formed on a second end thereof and corresponding to the notch 111.

The limitation member 5 partially extends out of the notch 111 and movably fits on the coupling segment 42 of the fastener 4, and the limitation member 5 includes a wide-diameter section 51 configured to retain with the notch 111 so as to limit the fastener 4, and the limitation member 5 also includes a narrow-diameter section 52 configured to remove the limitation member 5 from the fastener 4, wherein the second grip 21 has a fixing post 211 configured to retain with the hook 41.

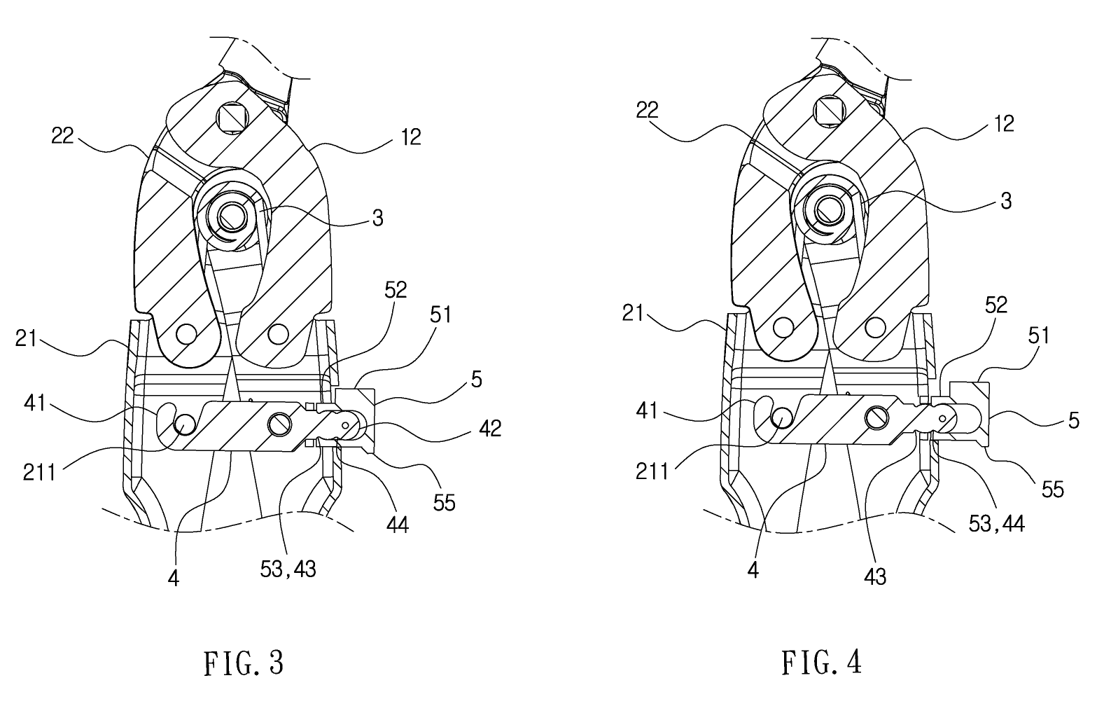

Referring to FIG. 3, when the hook 41 of the fastener 4 engages with the fixing post 211, the wide-diameter section 51 of the limitation member 5 is switched so as to correspond to the notch 111, thus avoiding swing of the hook 41 and fixing the pliers. Referring further to FIGS. 4-6, when the narrow-diameter section 52 of the limitation member 5 corresponds to the notch 111, the fastener 4 swings, and the limitation member 5 is pushed so as to urge the hook 41 to remove from the fixing post 211, thus switching the pliers.

The fastener 4 further includes a first retraction section 43 and a second retraction section 44 which are formed respectively on two sides of the coupling segment 42 of the fastener 4. The limitation member 5 further includes a locking protrusion 53 formed on an inner side thereof opposite to the narrow-diameter section 52 and alternatively locking with the first retraction section 43 or the second retraction section 44, wherein when the locking protrusion 53 locks with the first retraction section 43, the wide-diameter section 51 corresponds to the notch 111, and when the locking protrusion 53 locks with the second retraction section 44, the narrow-diameter section 52 corresponds to the notch 111, hence the limitation member 5 adjustably fixes the fastener 4 by way of the locking protrusion 53, the first retraction section 43, and the second retraction section 44.

The fastener 4 further includes a defining column 45 arranged on the coupling segment 42, and the limitation member 5 further includes two accommodation grooves 54 respectively defined on two sides thereof so as to accommodate the defining column 45, thus avoiding a removal of the limitation member 5 from the fastener 4.

The limitation member 5 further includes an operation tab 55 extending out of the notch 111 and configured to operate the limitation member 5 by pushing the operation tab 55.

The switch structure of the present invention further comprises a second spring 6 rotatably fitted on the fastener 4, wherein a first end of the second spring 6 abuts against the first grip 11, and a second end of the second spring 6 is biased against the fastener 4 so that one end of the hook 41 of the fastener 4 removes from the fixing post 211. Thereby, when the fastener 4 is unfastened, it does not interfere with the fixing post 211.

Accordingly, the switch structure of the present invention locks the pliers securely and safely.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A switch structure for pliers comprising: a first operation part, a second operation part, a first spring, a fastener, and a limitation member; wherein
the first operation part is rotatably connected with the second operation part so as to form a first grip, a second grip, a first cutting plier, and a second cutting plier, wherein the first spring is defined between the first grip and the second grip and pushes the first grip, the second first, the first cutting plier, and the second cutting plier, wherein the first grip has a notch formed on a peripheral side thereof;
the fastener is rotatably connected with the first grip, and the fastener includes a hook arranged on a first end thereof and corresponding to the second grip, the fastener also includes a coupling extension formed on a second end thereof and corresponding to the notch; and
the limitation member partially extends out of the notch and movably fits on the coupling segment of the fastener, and the limitation member includes a wide-diameter section configured to retain with the notch so as to limit the fastener, and the limitation member also includes a narrow-diameter section configured to remove the limitation member from the fastener, wherein the second grip has a fixing post configured to retain with the hook.

2. The switch structure as claimed in claim 1, wherein the fastener further includes a first retraction section and a second retraction section which are formed respectively on two sides of the coupling segment of the fastener, and the limitation member further includes a locking protrusion formed on an inner side thereof opposite to the narrow-diameter section and alternatively locking with the first retraction section or the second retraction section; wherein when the locking protrusion locks with the first retraction section, the wide-diameter section corresponds to the notch; wherein when the locking protrusion locks with the second retraction section, the narrow-diameter section corresponds to the notch.

3. The switch structure as claimed in claim 1, wherein the fastener further includes a defining column arranged on the coupling segment, and the limitation member further includes two accommodation grooves respectively defined on two sides thereof so as to accommodate the defining column.

4. The switch structure as claimed in claim 1, wherein the limitation member further includes an operation tab extending out of the notch.

5. The switch structure as claimed in claim 1 further comprising a second spring rotatably fitted on the fastener, wherein a first end of the second spring abuts against the first grip, and a second end of the second spring is biased against the fastener so that one end of the hook of the fastener removes from the fixing post.
